(19) United States
(12) Patent Application Publication
(10) Pub. No.: US 2011/0120173 A1
(43) Pub. Date: May 26, 2011

(54) HANGING STORAGE CONTAINER SYSTEM

(76) Inventor: Shari Olefson, Fort Lauderdale, FL (US)

(21) Appl. No.: 13/016,234

(22) Filed: Jan. 28, 2011

Related U.S. Application Data
(62) Division of application No. 11/866,705, filed on Oct. 3, 2007, now abandoned.
(60) Provisional application No. 60/848,880, filed on Oct. 3, 2006.

(51) Int. Cl. F25D 25/00; H01F 7/02; F25D 25/02; B65D 90/12

(52) U.S. Cl. 62/465; 248/206.5; 312/408; 220/751

(57) ABSTRACT

A system for removably hanging a storage container from a surface generally comprises a first coupler and a second coupler. The first coupler includes an elongated member that is one of attached to and formed integral with the surface. The second coupler is one of attached to and formed integral with the storage container. The second coupler removably engages the first coupler such that the storage container is removably hung from the surface.

### RELATED APPLICATIONS

This is a divisional of U.S. patent application Ser. No. 11/866,705, filed Oct. 3, 2007, and which claims the benefit of priority of U.S. Provisional Patent Application No. 60/848,880, filed Oct. 3, 2006, the entire contents of each of which are hereby incorporated herein by reference.

### BACKGROUND

Storage containers are often used in kitchens, laundry rooms, bathrooms, workshops, etc. for storing various items. Such containers are commercially available in a variety of shapes, sizes, and materials. Storage containers that have become the norm for storing foods, for example, include plastic containers with removable lids, and resealable plastic bags. These storage containers are typically stored on shelves in refrigerators and freezers to keep the contents fresh.

### SUMMARY

One embodiment of the invention includes a system for removably hanging a storage container from a surface. The system generally comprises a first coupler and a second coupler. The first coupler includes an elongated member that is one of attached to and formed integral with the surface. The second coupler is one of attached to and formed integral with the storage container. The second coupler removably engages the first coupler such that the storage container is removably hung from the surface.

In one embodiment, the first coupler can include an elongated channel and the second coupler can include a rail such that the elongated channel removably accommodates the rail. In another embodiment, the first and second couplers can include magnets that are attracted to each other.

### BRIEF DESCRIPTION OF THE DRAWINGS

FIG. 1 is a perspective view of a refrigerator constructed in accordance with the present invention and including a plurality of hanging storage container systems;

FIG. 2 is a perspective view of one embodiment of a hanging storage container system constructed in accordance with the present invention;

FIG. 3 is a front view of an alternative embodiment of a hanging storage container system constructed in accordance with the present invention;

FIG. 4 is a front view of another alternative embodiment of a hanging storage container system constructed in accordance with the present invention;

FIG. 5 is a front view of yet another alternative embodiment of a hanging storage container system constructed in accordance with the present invention;

FIG. 6 is a front view of still another alternative embodiment of a hanging storage container system constructed in accordance with the present invention; and

FIG. 7 is a front view of still another alternative embodiment of a hanging storage container system constructed in accordance with the present invention.

### DETAILED DESCRIPTION

In general, the present invention provides a hanging storage container system that maximizes the use of space under a shelf of a storage cabinet, for example.

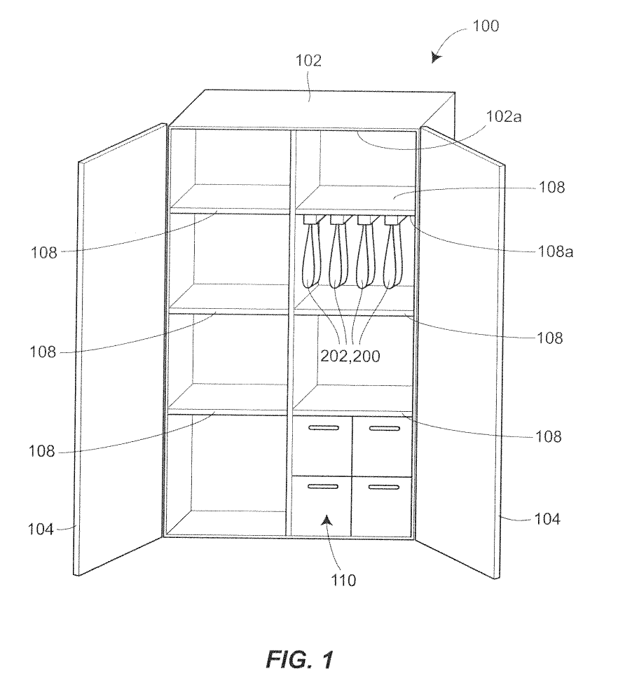

FIG. 1 depicts one such storage cabinet 100, which includes a refrigerator having a storage compartment 102 and a pair of doors 104. The storage compartment 102 includes a plurality of shelves 108 and can also include a plurality of drawers 110, for example, for storing various food items. The refrigerator 100 also includes a plurality of hanging storage container systems 200. Each system 200 generally comprises a container 202 that is removably hung from a bottom surface 108a of the top-most shelf 108 on the right-side of the refrigerator 100. In an alternative embodiment, the systems 200 can be hung from one or more similar shelves, for example, carried by the doors 104 of the refrigerator. The hanging containers 202 can include solid plastic containers or plastic bags, for example, or can be constructed of generally any other material suitable for the intended purpose. While FIG. 1 illustrates the refrigerator as being equipped with four hanging storage container systems 200, it should be appreciated that alternative embodiments of the refrigerator 100 can be equipped with more or less than four. Moreover, while the systems 200 are illustrated as being hung from the top-most shelf 108 on the right-side of the refrigerator 100, the systems 200 can alternatively be hung from any of the shelves 108, or even an inside surface 102a of the storage compartment 102.

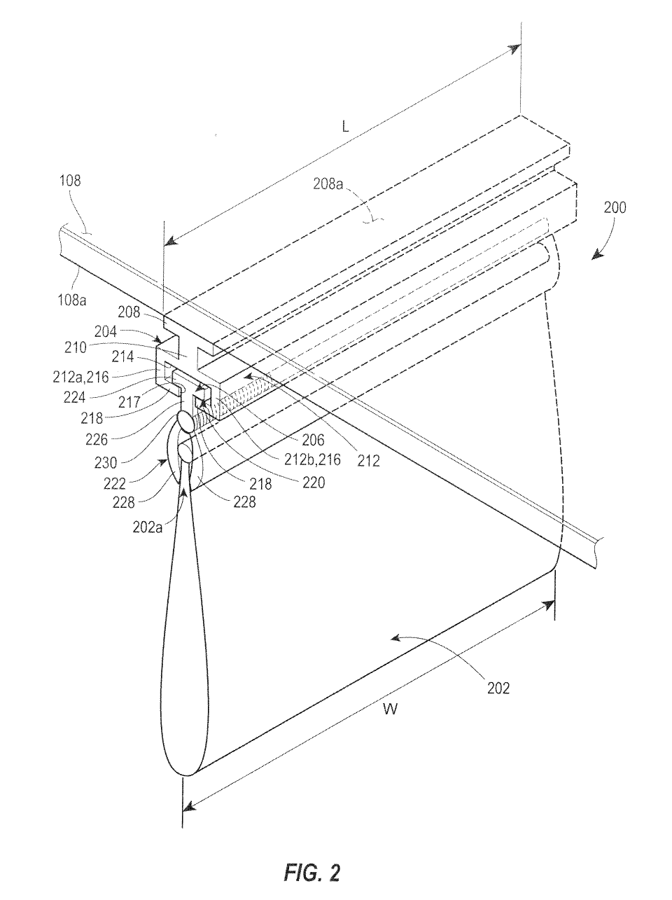

FIG. 2 depicts one embodiment of the storage system 200 of FIG. 1, which includes a channel-based system. In addition to the container 202, the storage system 200 includes a first coupler 204 and a second coupler 206. The first coupler 204 generally comprises an elongated component with a longitudinal dimension L that is approximately equal to a width dimension W of the container 202. In the disclosed embodiment, the first coupler 204 is adhered to the bottom surface 108a of the shelf 108 with double-sided adhesive tape, one or more suction cups, glue, or any other means.

The first coupler 204 comprises a one piece track formed of plastic, for example, by an extrusion process, an injection molding process, or any other manufacturing process. The first coupler 204 includes a base 208, a stem 210, and a sleeve 212. The base 208 is an elongated rectangular plate having atop surface 208a that is adhered to the bottom surface 108a of the shelf 108. The stem 210 extends between and connects the base 208 to the sleeve 212. The sleeve 212 includes a pair of opposing elongated sidewalls 212a, 212b defining an elongated channel 214 and an elongated opening 217. More specifically, as illustrated in FIG. 2, the elongated sidewalls 212a, 212h each include downward extending arm portions 216 and inward extending flange portions 218. So configured, the sleeve 212 of the first coupler 204 has a generally C-shaped cross-section and is adapted to removably accommodate at least a portion of the second coupler 206.

The second coupler 206 of the disclosed embodiment includes a support member 220 and a clip 222. The support member 220 includes an elongated member with a generally T-shaped cross-section defined by a plate portion 224 and a truss portion 226. The support member 220 can be constructed of plastic formed by an extrusion process, an injection molding process, or any other manufacturing process. The support member 220 can comprise a single component with a longitudinal dimension L that is approximately equal to the longitudinal dimension L of the first coupler 204.

The clip 222 of the second coupler 206, as depicted in FIG. 2, comprises a spring loaded clip and includes a spring 230 and a pair of clip arms 228. The spring 230 can include a torsion spring fixed between the truss portion 226 of the support member 220 and the clip arms 228. So configured, the spring 230 biases the clip arms 228 together. For example, in the depicted embodiment, the spring 230 biases the clip arms 228 together to clip the second coupler 206 onto an top portion 202a of the container 202, thereby removably securing the second coupler 206 to the container 202. Similar to the support member 220 described above, the clip arms 228 can comprise elongated one-piece components with longitudinal dimensions L that is approximately equal to the longitudinal dimension L of the first coupler 204.

While the second coupler 206 has been described as including a support member 220 and clip arms 228 having lengths approximately corresponding to the longitudinal dimension L of the first coupler 204, in an alternative embodiment, the support member 220 and clip arms 228, as well as the spring 230, can be substantially shorter than the first coupler 204. So configured, the container 202 can have a plurality of second couplers 206 clipped thereto and supported within the sleeve 212 of the first coupler 204. The plurality of second couplers 206 can be spaced apart along the top portion 202a of the container 202 to equally distribute the weight of the contents of the container 202 across the entire first coupler 204.

With the first and second couplers 204, 206 configured as described, the container 202 can easily be hung from the shelf 108 by first clipping the one or more second couplers 206 onto the container 202 and then, sliding the plate portion(s) 224 of the support member(s) 220 into the elongated channel 214 of the sleeve 212 of the first coupler 204. So configured, the flange portions 218 of the sleeve 212 are engaged by and support the plate portion(s) 224 of the support member(s) 220 of the second coupler(s) 206. The truss portion(s) 226 of the support member(s) 220 extend(s) through the elongated opening 217 defined by the sleeve 212, as depicted. To remove the container 202, the plate portion(s) 224 of the support member(s) 220 of the second coupler(s) 206 is/are simply slid out of the elongated channel 214 of the sleeve 212. Subsequently, to gain access to the container 202, the clip arms 228 of the clip(s) 222 can be spread apart, thereby releasing the container 202. In this embodiment, the container 202 preferably comprises a plastic bag such as a resealable plastic bag, for example.

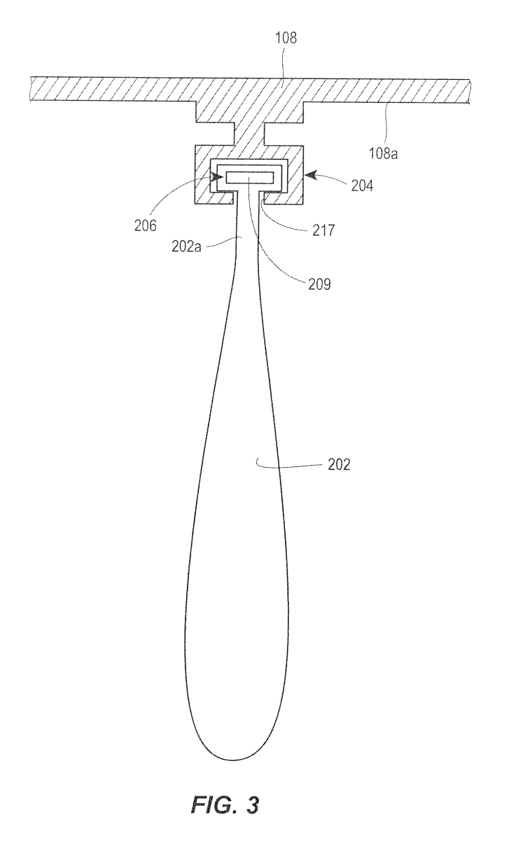

While the first coupler 204 of the system depicted in FIG. 2 has thus far been described as being adhered to or otherwise attached to the bottom surface 108a of the shelf 108, in alternative embodiments, the first coupler 204 can be formed integral with the shelf 108, i.e., the first coupler 204 and the shelf 108 can be formed as one piece, as depicted in FIG. 3. Moreover, as depicted in FIG. 3, the second coupler 206 can be formed integral with the container 202, i.e., the second coupler 206 and the container 202 can be formed as one piece. In the embodiment depicted in FIG. 3, the first coupler 204 is shaped identical to the first coupler 204 described above with reference to FIG. 2 and can be formed with the shelf 108 in an extrusion process, an injection molding process, or any other process. The second coupler 206 includes a rail 209 embedded within the top portion 202a of the container 202. For example, in one embodiment where the container 202 includes aplastic bag, the plastic material that forms the bag can also be formed around the rail 209, as depicted. The rail 209 can comprise a one-piece solid plastic component with a longitudinal dimension that is approximately equal to the longitudinal dimension L (as shown in FIG. 2) of the first coupler 204, or can comprise a plurality of rails 209 spaced apart along the longitudinal dimension L of the first coupler 204.

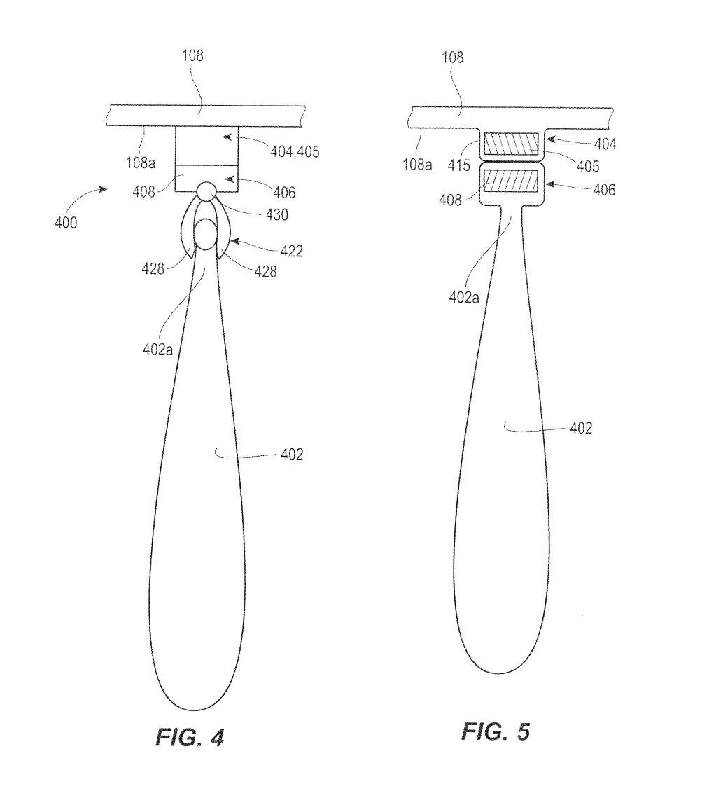

FIG. 4 illustrates an alternative embodiment of a hanging storage container system 400 constructed in accordance with the present invention, which includes a magnet-based system. Similar to the hanging storage container system 200 described above, the system 400 depicted in FIG. 4 includes a container 402, a first coupler 404, and a second coupler 406. The first coupler 404 includes a magnet 405 that is attached to the bottom surface 108a of the shelf 108 with double-sided adhesive tape, suction cups, glue, or by any other means. The magnet 405 is an elongated magnet with a square cross-section. The magnet 405 includes a longitudinal dimension L similar to the longitudinal dimension L described above with respect to the first component 204 depicted in FIG. 2, i.e., approximately equal to a width dimension W of the container 402.

The second coupler 406 includes a magnet portion 408 and a clip 422. The magnet portion 408 of the second coupler 406 can include an elongated magnet having a rectangular cross-section, for example, and a longitudinal dimension that is approximately equal to a longitudinal dimension L (as shown in FIG. 2) of the first coupler 404. The clip 422 comprises a spring-loaded clip and includes a spring 430 and a pair of clip arms 428. The spring 430 can include a torsion spring fixed between the magnet portion 408 and the clip arms 428. So configured, the spring 430 biases the clip arms 428 together to removably secure the second coupler 406 to the container 402. Similar to the second coupler 206 described above with reference to FIG. 2, the magnet portion 408 of the second coupler 406 depicted in FIG. 4 can include longitudinal dimensions that are approximately equal to the longitudinal dimension L of the first coupler 404.

In an alternative embodiment, the magnet portion 408 and clip arms 428, as well as the spring 430, can be substantially shorter than the magnet 405 of the first coupler 404. So configured, the container 402 can have a plurality of second couplers 406 clipped thereto and in magnetic engagement with the longitudinal dimension L of the first coupler 404. The plurality of second couplers 406 can be spaced apart along a top portion 402a of the container 402 to equally distribute the weight of the contents of the container 402 across the entire first coupler 404.

Regardless of the specific arrangement of the one or more second couplers 406, the container 402 is hung from the shelf 108 by placing the magnet portion(s) 408 of the second coupler(s) 406 in close proximity to the magnet 405 of the first coupler 404. In a preferred embodiment, the polarity of the magnet 405 of the first coupler 404 is opposite to the polarity of the magnet portion(s) 408 of the second coupler(s) 406. So configured, the magnet 405 and the magnet portion(s) 408 are attracted to each other and securely hang the container 402 from the shelf 108. To remove the container 402, the second coupler(s) 406 can simply be pulled away from the magnet 405 of the first coupler 404. Subsequently, to gain access to the container 402, the second couplers 406 can be removed from the container 402 by spreading the clip arms 428 apart to release the container 402.

While the first coupler 404 of the system 400 depicted in FIG. 4 has thus far been described as being adhered to or otherwise attached to the bottom surface 108a of the shelf 108, in alternative embodiments, the first coupler 404 can be formed integral with the shelf 108, i.e., the first coupler 404 and the shelf 108 can be formed as one piece, as depicted in FIG. 5. Moreover, as depicted in FIG. 5, the second coupler 406 can be formed integral with the container 402, i.e., the second coupler 406 and the container 402 can be formed as one piece. In the embodiment depicted in FIG. 5, the first coupler 404 is identical to the first coupler 404 described above with reference to FIG. 4 in that it comprises an elongated magnet 405. The magnet 405 is embedded within a sleeve 415 formed in the shelf 108 by an extrusion process, an injection molding process, or any other process. The second coupler 406 includes a magnet portion 408 embedded within the top portion 402a of the container 402. For example, in one embodiment where the container 402 includes a plastic bag, the plastic material can be formed around the magnet portion 408, as depicted. The magnet portion 408 can comprise a single elongated magnet that extends the longitudinal dimension L of the magnet 405 of the first coupler 404, or alternatively, can comprise a plurality of magnet portions 408 spaced apart along the longitudinal dimension L of the first coupler 404, as described above with reference to FIG. 4.

While the integral magnet 405 of the first coupler 404 depicted in FIG. 5 is illustrated as being carried within the sleeve 415 of the shelf 108, in an alternative embodiment, the entire bottom surface 108a of the shelf 108 can be magnetic. So configured, the second coupler(s) 406 could advantageously be positioned into engagement with the bottom surface 108a of the shelf 108 at generally any location for hanging the containers 402.

Moreover, while the magnet portion 408 of the second coupler 406 of FIG. 5 has been described as merely including a magnet, in alternative embodiments, the container 402 can include a resealable device, such as a. Zip-Loc® device, for example, that is constructed of a magnetic material or other material capable of magnetic attraction to the magnet 405 of the first coupler 404, and therefore constitutes the magnet portion 408 of the second coupler 406.

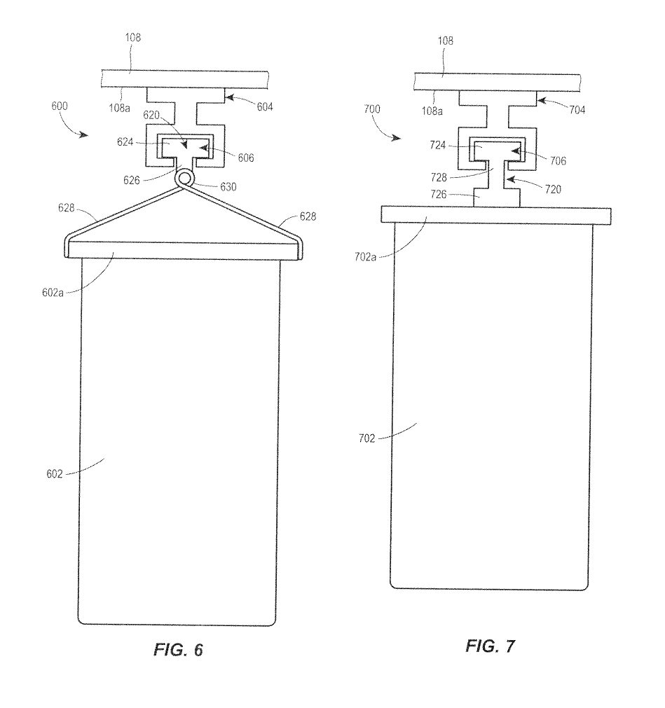

As mentioned above, the hanging storage container system 200, 400 of the present invention can be adapted for use with plastic bag containers, or for solid plastic containers. FIG. 6 illustrates one embodiment of a hanging container storage system 600 including a solid container 602. The solid container 602 of the disclosed embodiment includes a cover 602a. Similar to the system 200 described above with reference to FIG. 2, the system 600 includes a first coupler 604 and a second coupler 606 removably hanging the container 602 from a shelf 108.

The first coupler 604 of the embodiment of FIG. 6 is identical to the first coupler 204 of the embodiment described above in reference to FIG. 2 and therefore the details will not be repeated. The second coupler 606 includes a support member 620 and a clip 622. The support member 620 includes a plate portion 624 and a truss portion 626 defining a generally T-shaped cross-section, similar to the support member 220 described above with reference to FIG. 2. The clip 622 includes a spring 630 and a pair of spring arms 628. The spring 630 can include a torsion spring that biases the clip arms 628 together. For example, as depicted in FIG. 6, the spring 630 biases the clip arms 628 together to engage the cover 602a of the container 602. Therefore, it should be appreciated that the second coupler 606 of the system 600 depicted in FIG. 6 is generally similar to the system 200 described above with reference to FIG. 2. The clip arms 628 engaging the cover 602a of the solid container 602, however, are substantially longer than the clip arms 228 described above for clipping the sides of the plastic bag container 202. The steps required for hanging and/or removing the container 602 from the shelf 108 are generally similar to the steps described above with reference to the system 200 depicted in FIG. 2.

FIG. 7 illustrates another embodiment of a hanging container storage system 700 including a solid container 702. Similar to the system 600 depicted in FIG. 6, the system 700 includes a first coupler 704 and a second coupler 706 removably hanging the container 702, which includes a cover 702a, from the shelf 108. The first coupler 704 of the embodiment of the system 700 in FIG. 7 is identical to the first couplers 204, 604 of the embodiments described above in reference to FIGS. 2 and 6, and therefore the details will not be repeated. The second coupler 706, however, only includes a support member 720. The support member 720 includes a top plate portion 724, a bottom plate portion 726, and a truss portion 728 extending between and connecting the top and bottom plate portions 724, 726. So configured, the support member 720 includes a cross-section that is similar to a conventional I-beam, for example. In the disclosed embodiment, the bottom plate portion 726 is adhered to the cover 702a of the container 702. In an alternative embodiment, the entire second coupler 706 may be formed integral with the cover 702a, i.e., the second coupler 706 and the cover 702a can be formed as one piece. In either configuration, the steps required for hanging and/or removing the container 702 from the shelf 108 are generally similar to the steps described above with reference to the system 200 depicted in FIG. 2.

While the solid storage containers 602, 702 have only been expressly described as being used with channel-based storage container systems 600, 700, it should be appreciated that the magnet-based storage container systems 400 described above with reference to FIGS. 4 and 5 can also be adapted for use with the solid storage containers 600, 700. Specifically, the system 400 depicted in FIG. 4 could be reconfigured to include larger clip arms 428 for engaging the covers 602a, 702a of the solid containers 602, 702.

Furthermore, in one embodiment, the covers 602a, 702a of the solid containers 602, 702 could be manufactured to include integral magnet portions similar to the magnet portion 408 embedded in the container 202 of FIG. 5. In yet another embodiment, a magnet portion may be adhered to the cover 602a, 702a of the solid containers 602, 702 with double-sided adhesive tape, for example, to adapt the solid containers 602, 702 for use with the magnet-based first couplers 404 described with reference to FIGS. 4 and 5. In yet another alternative embodiment, the entire cover 602a, 702a can be constructed of a magnetic material or a material capable of magnetic attraction to the magnet 405 of the first coupler 404 depicted in FIG. 5, for example.

Further still, while the containers 202, 402 depicted in FIGS. 2-5 have been described herein as including plastic bags, such description is merely explanatory and the containers 202, 402 may include solid containers, wire mesh containers, nets, or any other type of container constructed of any other type of material. Similarly, while the containers 602, 702 depicted in FIGS. 6 and 7 have been described as comprising solid containers, they too could comprise plastic bags, wire mesh containers, nets, or any other type of container constructed of any other type of material.

While the various systems 200, 400, 600, 700 have been described herein as including a first coupler 204, 404, 604, 704 with a longitudinal dimension L generally equal to a width dimension W of the respective containers 202, 402, 602, 702, in alternative embodiments, the first couplers 204, 404, 604, 704 can include longitudinal dimensions L greater than the width dimensions W of the containers 202, 402, 602, 702 such that a single, first coupler 204, 404, 604, 704 could accommodate more than one container 202, 402, 602, 702.

Accordingly, in light of the foregoing, it should be appreciated that the present invention provides an integrated disposed or reusable storage container system that maximizes space efficiency, ease of accessibility, and organization within a storage cabinet such as a refrigerator. This is primarily accomplished by utilizing the bottom surface 108a of the shelves 108 to support storage containers 202, 402, 602, 702 that have traditionally been stored on top of the shelves 108, which often limits a consumer's use of the available storage space within the refrigerator to approximately 50%. The increase in spatial efficiency provided by the systems 200, 400, 600, 700 of the present invention therefore effectively increases the storage capacity of the refrigerator 100 and alleviates the need for many consumers to purchase a secondary refrigerator or freezer for storing perishable foods.

Finally, it should be understood from the foregoing description that the storage container systems 200, 400, 600, 700 of the present invention can be manufactured and sold with the refrigerator 100. Alternatively, the systems 200, 400, 600, 700 can be manufactured separate from the refrigerator and sold as an accessory, or an after-market kit. For example, one accessory or after-market kit can include a plurality of first couplers 204, 404, 604, 704, a plurality of second couplers 206, 406, 606, 706 corresponding to the first couplers 204, 404, 604, 704, and a plurality of containers 202, 402, 602, 702 corresponding to the first couplers 204, 404, 604, 704 and the second couplers 206, 406, 606, 706. Such kits could be designed specific to the various brands of refrigerators, or can be designed generic to all refrigerator manufacturers.

While the storage systems 200, 400, 600, 700 have thus far been described as being adapted for use with refrigerators, it should be appreciated that the present invention is not limited to refrigerators. For example, the hanging storage container systems 200, 400, 600, 700 can also be utilized in conjunction with kitchen/bathroom/laundry-room cabinets, workshop or other shelving assemblies, under counters, or in any other location that may benefit from the advantages provided thereby.

In light of the foregoing, the present invention is not limited to the examples and embodiments described herein but rather is defined by the spirit and scope of the following claims, and all equivalents thereof.

What is claimed:

1. A system for removably hanging a storage container from a surface, the system comprising:
a first magnetic coupler adapted to be carried by the surface;
aplastic storage container;
a cavity defined in a top portion of the plastic storage container; and
a second magnetic coupler disposed within the cavity and embedded within the plastic storage container, the second magnetic coupler adapted to removably secure the plastic storage container to the first magnetic coupler through magnetic attraction such that the plastic storage container is adapted to be removably hung from the surface.

2. The system of claim 1, further comprising a storage shelf and wherein the first magnetic coupler is formed integral with a bottom surface of the storage shelf.

3. The system of claim 2, wherein the first magnetic coupler comprises an elongated magnet embedded within an elongated sleeve carried on the bottom surface of the storage shelf.

4. The system of claim 2, wherein the first magnetic coupler comprises the entire bottom surface of the storage shelf.

5. The system of claim 1, wherein h storage container comprises one of a plastic bag and a hard plastic container.

6. A system comprising:
a storage shelf comprising a bottom surface;
a first magnet associated with the bottom surface of the storage shelf;
a storage container; and
a second magnet associated with the storage container, the second magnet removably hanging the storage container to the bottom surface of the storage shelf through magnetic attraction with the first magnet.

7. The system of claim 6, wherein the first magnet is embedded within a sleeve of the storage shelf.

8. The system of claim 6, wherein the first magnet comprises the entire bottom surface of the storage shelf.

9. The system of claim 6, wherein the second magnet is embedded within a top portion of the storage container.

10. The system of claim 6, wherein the storage container includes plastic material formed around the second magnet.

11. The system of claim 6, wherein the storage container comprises one of a plastic bag and a hard plastic container.

12. The system of claim 6, further comprising a refrigerated storage cabinet accommodating the storage shelf, the first magnet, the storage container, and the second magnet.

13. A refrigerator, comprising:
a refrigerated storage cabinet;
a storage shelf disposed within the storage cabinet and including a first magnetic coupler associated with a bottom surface of the storage shelf;
a plastic storage container; and
a second magnetic coupler associated with a top portion of the plastic container, the second magnetic coupler hanging the plastic storage container from the bottom surface of the storage shelf through magnetic attraction with the first magnetic coupler.

14. The refrigerator of claim 13, wherein the bottom surface of the storage shelf includes an elongated plastic sleeve, and the first magnetic coupler comprises an elongated magnet embedded within the elongated plastic sleeve.

15. The refrigerator of claim 13, wherein the second magnetic coupler comprises a magnet embedded within the top portion of the plastic container.

16. The refrigerator of claim 13, wherein the bottom surface of the storage shelf is entirely magnetic and comprises the first magnetic coupler.
